(19) United States
(12) Patent Application Publication
(10) Pub. No.: US 2007/0294224 A1
(43) Pub. Date: Dec. 20, 2007

(54) TRACKING DISCRETE ELEMENTS OF DISTRIBUTED TRANSACTIONS

(76) Inventor: JEAN-JACQUES HELER, Palo Alto, CA (US)

Correspondence Address: PATTERSON & SHERIDAN, LLP/IBM SVL, 3040 POST OAK BLVD., SUITE 1500, HOUSTON, TX, 77056-6582, US

(21) Appl. No.: 11/424,685

(22) Filed: Jun. 16, 2006

(51) Int. Cl. G06F 17/30

(52) U.S. Cl. 707/3

(57) ABSTRACT

Methods and systems for grouping two or more communications on a computer network into a transaction. One embodiment includes a method of tracking an asynchronous communication between two applications. The method includes receiving a first and third event record associated with a first and third application, wherein the first and third event records indicate the occurrence of an interaction between the first and third applications. The method may further include receiving a second event record from a second application. The second event record may be used by a managing server to group the first and third interactions as belonging to a common transaction.

### CROSS-REFERENCE TO RELATED APPLICATIONS

This application is related to U.S. patent application Ser. No. 11/227,854, Attorney Docket No. SVL920050020US1, entitled End-To-End Transaction Tracking in the Enterprise, filed Sep. 14, 2005, by Heler, incorporated by reference in its entirety.

### BACKGROUND OF THE INVENTION

1. Field of the Invention

The present invention relates generally to communication networks and, more specifically, to data tracking in computer based communications networks.

2. Description of the Related Art

As computer technology has developed, so has the need for and use of distributed computing. It is commonplace for a first computer program to request and utilize resources from a second computer program or data source, or for the first computer program to send messages to the second computer program. Frequently, the second computer program or data source may be executing on a separate computer system from the first computer program, and therefore communication between the two programs over a computer network may be necessary. Thus, the processing of a single transaction within the computer network may require numerous communications, or interactions, between resources distributed throughout the network.

While the distribution of resources is an efficient manner for processing information, it may result in a good deal of interactions traveling over the network. At any given moment, it is not uncommon for large systems to process thousands or even millions of such requests, responses and/or messages as they travel among machines on a computer network. To manage these computer networks, system administrators use numerous tools to observe the quality of such a network. The quality of a computer network may be measured by several metrics, including processor loads, memory loads, communication transmission times, and network traffic.

One such tool, described in the related application referenced above, includes a monitoring tool which utilizes individual tokens to tag and track interactions across a computer network. This tool is capable of identifying a single interaction, as well as grouping some forms of related interactions into an individual transaction. While the monitoring tool can track some transactions, the protocol defined in the related application does not address certain scenarios involving asynchronous communication between programs and/or data sources where it may be difficult to determine which individual messages or interactions between different applications are related to one other. Thus, although, monitoring interactions over a computer network with distributed resources may provide a tool for observing the quality of a computer network; such a tool may not provide information on the quality of the processing of an individual transaction.

Accordingly, what is needed is an improved method and system for grouping two or more interactions on a computer network into a transaction.

### SUMMARY OF THE INVENTION

The present invention generally provides methods and systems for grouping two or more communications on a computer network into a transaction. In one embodiment, a computer-implemented method of tracking an asynchronous communication between two applications may include receiving a first event record associated with a first application. The first event record may indicate that the first application sent a first communication to a second application. The method may also include receiving a second event record associated with the second application. The second event record may indicate that the second application received a second communication from the first application. The method may also include determining whether the second communication, received by the second application, corresponds to the first communication sent by the first application. Furthermore, the method may include receiving a third event record from a monitoring application configured to monitor communications between the first application and the second application. The third event record may include a transaction identifier used to correlate the first and second event records as belonging to a group of one or more event records related to a common transaction.

In one embodiment, a computer readable storage medium containing a program product may be provided. When executed by a processor, the program product may perform an operation that may include receiving a first event record associated with a first application. The first event record may indicate that the first application sent a first communication to a second application. The operation may also include receiving a second event record associated with the second application. The second event record may indicate that the second application received a second communication from the first application. The operation may also include determining whether the second communication, received by the second application, corresponds to the first communication sent by the first application. Furthermore, the operation may include receiving a third event record from a monitoring application configured to monitor communications between the first application and the second application. The third event record may include a transaction identifier used to correlate the first and second event records as belonging to a group of one or more event records related to a common transaction.

In one embodiment, a system for monitoring communications between applications in a distributed computing environment may include a first application configured to send a first communication to a second application. The first communication may correspond to a first event record. The system may also include the second application configured to receive a second communication from the first application. The second communication may correspond to a second event record. The system may also include a managing server configured to determine whether the second communication, received by the second application, corresponds to the first communication sent by the first application. The managing server may be further configured to receive a third event record from a monitoring application. The monitoring application may be configured to monitor communications between the first application and the second application, and the third event record may include a transaction identifier used to correlate the first and second event records as belonging to a group of one or more event records related to a common transaction.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a networked system in which embodiments of the present invention may be implemented;

FIG. 2 is a block diagram illustrating a data structure of a GPS_MAP event record used to correlate related interactions into transactions, according to one embodiment of the invention;

FIG. 3 is a flow diagram depicting a process for creating the GPS_MAP event record, according to one embodiment of the invention;

FIG. 4A is a block diagram illustrating a scenario in which a monitored first application sends an interaction to a monitored second application, according to one embodiment of the invention;

FIG. 4B is a block diagram illustrating the dataflow during an interaction in which the sending and receiving applications are monitored, according to one embodiment of the invention;

FIG. 5A is a block diagram illustrating a scenario in which a non-monitored first application sends an interaction to a monitored second application, according to one embodiment of the invention;

FIG. 5B is a block diagram illustrating the dataflow during an interaction in which the sending application is not monitored and the receiving application is monitored, according to one embodiment of the invention;

FIG. 6A is a block diagram illustrating a scenario in which a monitored first application sends an interaction to a non-monitored second application, according to one embodiment of the invention;

FIG. 6B is a block diagram illustrating the dataflow during an interaction in which the sending application is monitored and the receiving application is not monitored, according to one embodiment of the invention;

FIG. 7A is a block diagram illustrating a scenario in which a non-monitored first application sends an interaction to a non-monitored second application, according to one embodiment of the invention;

FIG. 7B is a block diagram illustrating the dataflow during an interaction in which neither the sending nor the receiving applications are monitored, according to one embodiment of the invention;

FIG. 8 is a flow diagram depicting a process for determining which event records the interaction routing system may send to the interaction monitor, according to one embodiment of the invention; and

FIG. 9 is a flow diagram depicting a process for determining an interaction's transaction, according to one embodiment of the invention.

### DETAILED DESCRIPTION OF THE PREFERRED EMBODIMENTS

The present invention generally provides methods and systems for grouping two or more communications on a computer network into a transaction. In one embodiment, a computer-implemented method of tracking an asynchronous communication between two applications may include receiving a first event record associated with a first application. The first event record may indicate that the first application sent a first communication to a second application. The method may also include receiving a second event record associated with the second application. The second event record may indicate that the second application received a second communication from the first application. The method may also include determining whether the second communication, received by the second application, corresponds to the first communication sent by the first application. Furthermore, the method may include receiving a third event record from a monitoring application configured to monitor communications between the first application and the second application. The third event record may include a transaction identifier used to correlate the first and second event records as belonging to a group of one or more event records related to a common transaction.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

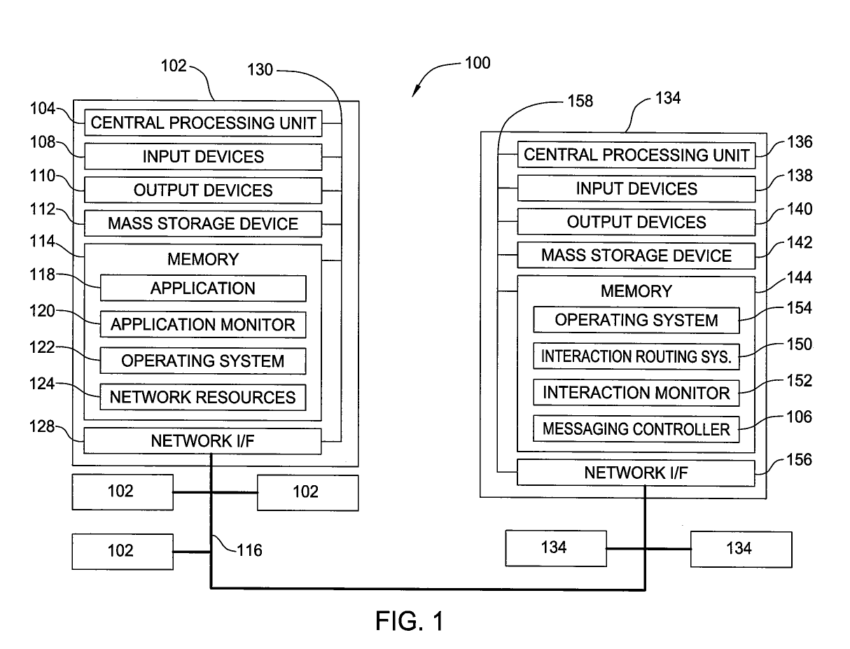

One embodiment of the invention is implemented as a program product for use with a computer system such as, for example, the network environment 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

As described in End-to-End Transaction Tracking in the Enterprise, a computer system may possess one or more application environments, a software environment in which applications may be executed. For example, application environments may include a Java® 2 Platform Enterprise Edition (J2EE®) application server instance, a Customer Information Control System (CICS®), or a messaging infrastructure like WebSphere® MQ. The above application environments have several significant differences and yet they serve the same purpose: to provide an execution environment for user applications.

For instance the J2EE® application server is a Java® container where servlets, Enterprise Java® Beans (EJBs), and other J2EE® applications may run. Exemplary J2EE® application servers include WebSphere® Application Server (WAS) and Weblogic®. Both distributed WAS and Weblogic® application server instances are implemented as single address spaces or Unix® processes hosting a Java® Virtual Machine (JVM).

Similarly, CICS® may be a distributed or z/OS Transaction Processing Monitor. CICS® may be implemented as a subsystem consisting of several regions (address spaces). However a single CICS® region, usually Application Owning Region (AOR), may be considered an application environment. In the AOR application environment, user applications may run as transactions or tasks.

As alluded to above, application environments may possess one or more regions. A region may be an address space that may be a portion of memory. In some embodiments, a region may be a process. A region may comprise at least one unit of execution. In general, a unit of execution may be a group of instructions which may be executed as a unit, and may have a beginning and an end. Two or more units of execution may communicate between each other with interactions. Interactions, as referred to herein, constitute communications between resources distributed throughout a computer network. Further, a group of interactions may all be related to one another as part of a common job, task or function, referred to herein as a transaction. For example, to process a user request, a first application may initiate numerous interactions with other applications over a data communications network.

The interactions sent and received by a unit of execution may be monitored by a collector, also called an application monitor. The application monitor may monitor one or more application environments. Therefore, in one embodiment, one application monitor may monitor numerous application environments, each containing multiple regions, each with a plurality of units of execution which may communicate between each other. Proceeding in this manner may be cumbersome and may add unnecessary complexity to this document. For clarity, this document describes interactions between two applications, but one skilled in the art will recognize that the interactions may occur within the framework discussed above and should not be limited to a particular embodiment disclosed herein.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Network and Computer Systems

FIG. 1 is a block diagram illustrating a networked system 100 in which embodiments of the present invention may be implemented. In general, the networked system 100 includes a client (e.g., user's) computer 102 (four such client computers 102 are shown) and at least one server 134 (three such servers 134 are shown). The client computer 102 and the server computer 134 are connected via a network 116. In general, the network 116 may be a local area network (LAN) and/or a wide area network (WAN). In a particular embodiment, the network 116 is the Internet.

Client computers 102 and server computers 134 provide a simplified representation of a variety of existing computer systems, e.g., desktop computers, server computers, laptop computers, tablet computers and the like. Additionally, the client systems 102 may be representative of other computing devices such as personal digital assistants (PDA's) and Wireless Markup Language (WML) enabled mobile phones. The invention, however, is not limited to any particular computing system and may be adapted to take advantage of new computing systems and devices as they become available. Network 116 may represent any suitable network, including small local area networks, corporate intranets, large wide area networks such as the Internet, or any combination thereof.

The client computer 102 includes a Central Processing Unit (CPU) 104 connected via a bus 130 to a memory 114, storage 112, an input device 108, an output device 110, and a network interface device 124. The input device 108 can be any device to give input to the client computer 102. For example, a keyboard, keypad, light-pen, touch-screen, track-ball, or speech recognition unit, audio/video player, and the like could be used. The output device can be any device to give output to the user, e.g., any conventional display screen or set of speakers along with their respective interface cards, i.e., video card and sound card. Although shown separately from the input device 108, the output device 110 and input device 108 could be combined. For example, a display screen with an integrated touch-screen, a display with an integrated keyboard, or a speech recognition unit combined with a text speech converter could be used.

The network interface device 128 may be any entry/exit device configured to allow network communications between the client computer 102 and the server computers 134 via the network 116. For example, the network interface device 128 may be a network adapter or other network interface card (NIC).

Storage 124 is preferably a Direct Access Storage Device (DASD). Although it is shown as a single unit, it could be a combination of fixed and/or removable storage devices, such as fixed disc drives, floppy disc drives, tape drives, removable memory cards or optical storage. The memory 114 and storage 112 could be part of one virtual address space spanning multiple primary and secondary storage devices.

The client computer 102 is generally under the control of an operating system 122, which is shown in the memory 114. Illustrative operating systems, which may be used to advantage, include Linux and Microsoft's Windows. More generally, any operating system supporting the functions disclosed herein (e.g. inter-application communication over a network) may be used.

Information located in the memory 114 may also include a generic application 118 and its associated monitoring application 120, as well as network resources 124. The generic application 118 may be any application that communicates with data sources and/or other applications to accomplish a task. In one embodiment, the data sources and/or other applications may be located on a different client computer 102 than the generic application 118. The application monitor 120 may track all interactions between the generic application 118 and another application or data source and may communicate the presence of such interactions over the network 116 to the interaction monitor 152 running on the server 134. The network resources 124 may be used to allow other applications access to the network 116 via the network interface 128.

The memory 114 is preferably a random access memory sufficiently large to hold the necessary programming and data structures of the invention. While the memory 114 is shown as a single entity, it should be understood that the memory 114 may in fact comprise a plurality of modules, and that the memory 114 may exist at multiple levels, from high speed registers and caches to lower speed but larger DRAM chips.

Illustratively, the memory 114 includes an application 118 that, when executed on CPU 104, provides support for exchanging information between the various server computers 134 and locating network addresses at one or more of the server computers 134. In one embodiment, the application 118 is a web browser that includes a web-based Graphical User Interface (GUI), which allows the user to navigate and display web pages located on the Internet. However, more generally the application may be a thin client application configured to transfer data (e.g., HTML, XML, Java®, etc.) between the client computer 102 and the server computers 134.

Each server computer 134 generally includes a CPU 136, a memory 144, a network interface device 156, input devices 138, output devices 140, and a storage device 142, coupled to one another by a bus 158. Memory 144 may be a random access memory sufficiently large to hold the necessary programming and data structures that are located on the server 134. The programming and data structures may be accessed and executed by the CPU 136 as needed during operation. As shown, memory 144 contains an operating system 154, an interaction routing system (IRS) 150, an interaction monitor 152, and a messaging controller 106. The operating system 154 may manage server hardware and applications executing on the server computer 134. The IRS 150 may facilitate communication between two or more applications 118 running on different client computers 102. By way of illustration, the IRS 150 may be an instance of the Apache Tomcat® or IBM WebSphere® products. However, more generally, it is contemplated that the invention is adaptable to any application server and applications.

The interaction monitor 152 may utilize communication event records generated by the application monitor 120 and/or the IRS 150 to determine the status of the network 116. The messaging controller 106 may temporarily store a message in a queue when the message is sent from one client computer 102 to another. The message may be a part of a transaction, where a requesting first application requires a return message from a second application. While the IRS 150, the interaction monitor 152 and the messaging controller 106 are depicted as being on the same server 134, each may be contained independently on a server 134 irrespective of the location of the other two applications.

FIG. 1 is merely one hardware/software configuration for the networked client computer 102 and server 134. Embodiments of the present invention can apply to any comparable hardware configuration, regardless of whether the computer systems are complicated, multi-user computing apparatuses, single-user workstations or network appliances that do not have non-volatile storage of their own. Further, it is understood that while reference is made to particular languages, including HTML, XML and the JAVA® programming language, the invention is not limited to a particular language, standard or version. Accordingly, persons skilled in the art will recognize that the invention is adaptable to other languages and that the invention is also adaptable to future changes in a particular language as well as to other languages presently unknown. Further, the IRS 150 and the messaging controller 106 are merely illustrative and other embodiments adapted to support any known and unknown protocols/functions are contemplated.

### The GPS_MAP Event Record

Event records define one or more aspects of an interaction traveling over a network 116 and may be generated by various applications (e.g., 118, 120 and 150) connected to the network 116. Optionally, event records, once generated, may be sent to a monitoring tool to aid in gauging network performance. As outlined in the related case titled “End-to-End Transaction Tracking in the Enterprise,” a protocol (also outlined below) utilizes a monitoring tool called a global publishing server (GPS) and GPS event records may be used to track interactions between two or more applications 118. In one embodiment, there are two primary types of interactions: messages and invocations. More generally however, as describe above, an interaction refers to data communications occurring between to or more applications imitated as part of a common job, task or function, i.e., as part of a common transaction.

For example, an interaction includes a message between two applications 118 sent from a first application 118 to a messaging controller 106, where the message may be temporarily stored until it is retrieved by a second application 118. Tracking of messages may be handled with the following event records: GPS_PUT_START, GPS_PUT_END, GPS_GET_START and GPS_GET_END. In one embodiment, the GPS_PUT START and GPS_PUT_END event records may be sent by a first application monitor 120 to the interaction monitor 152 when the first application 118 initiated and completed sending a message to the messaging controller 106. Similarly, the GPS_GET_START and GPS_GET_END event records may be sent by a second application monitor 120 to the interaction monitor 152 when the second application 118 initiated and completed retrieval of the message from the messaging controller 106.

Another form of an interaction includes an invocation between two applications 118 that may be sent directly from a first application 118 to a second application 118 (e.g., a form of remote procedure call such as RMI/IIOP). The first application 118 generally requires a response interaction from the second application 118. Tracking of invocations may be handled with the following event records: GPS_INVOKE_START, GPS_INVOKE_END, GPS_RECEIVE_START and GPS_RECEIVE_END. In one embodiment, the GPS_INVOKE_START and GPS_INVOKE_END event records may be sent by the first application monitor 120 to the interaction monitor 152 when the first application 118 initiated and completed sending an invocation to the second application 118. Similarly, the GPS_RECEIVE_START and GPS_RECEIVE_END event records may be sent by the second application monitor 120 to the interaction monitor 152 when the second application 118 began and completed retrieval of the invocation from the first application 118.

Given the similarities between these two groups of event records, further examples will utilize messaging type event records, but it should be understood that invocation type event records are equally applicable to the present invention.

In one embodiment, data may be sent to the interaction monitor 152 with each event record. Such data may include an application identifier, a token identifier and a timestamp. An application identifier is an identifier that may indicate the application 118 which caused a particular event record to be sent to the interaction monitor 152. In comparison, a token identifier is an identifier that may indicate the interaction which caused the particular event record to be sent to the interaction monitor 152, and a timestamp is an identifier that may indicate when the particular event record was sent.

In one embodiment, the protocol described above may be used to obtain an end-to-end view of the processing of interactions between various applications. This may be accomplished by comparing token identifiers in event records received by the interaction monitor 152 (e.g., GPS_PUT_START(app_ID, token_ID_A, timestamp), GPS_GET_START(app_ID, token_ID_B, timestamp), etc.). Event records containing identical token identifiers may be a part of a single interaction. In certain cases, specifically in synchronous communication, the interaction monitor 152 may be able to analyze patterns of interactions and thereby group two or more interactions into a transaction. Specifically, this occurs when a known path, e.g., A→B and B→C, occurs for synchronous interactions. Thus, the interaction monitor 152 may correlate the interactions forming the path into one transaction, e.g., A→B→C. In other cases, external information may be needed in order to group related interactions.

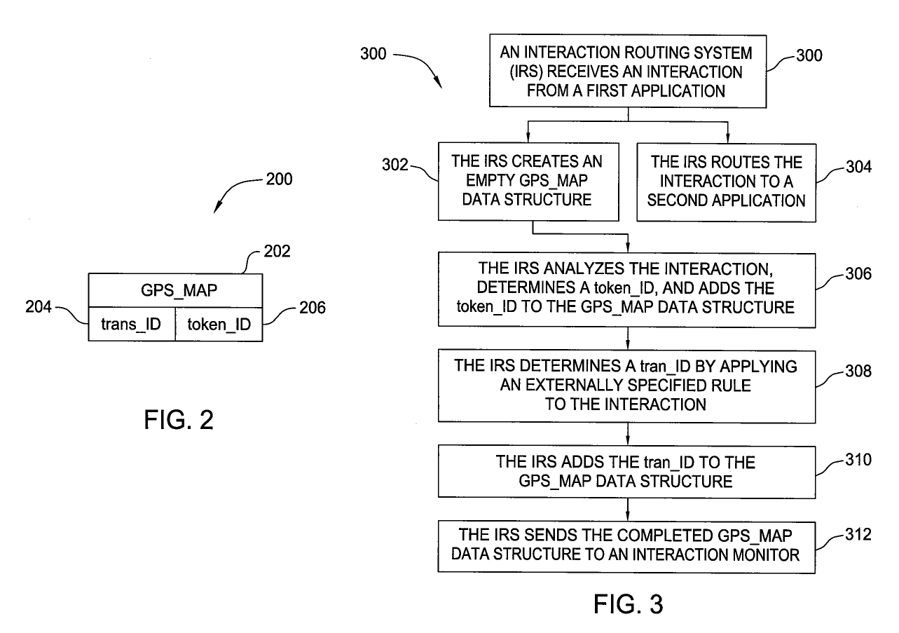

In one embodiment, a correlating event record may be added to the protocol defined above to provide such external information. The correlating event record may be sent for each interaction, and may contain a transaction identifier to relate each interaction to a transaction. For example, a GPS_MAP event record may be used by the interaction monitor 152 to correlate related interactions into transactions. The GPS_MAP event record is a necessary addition to the protocol described above so that its capability may be extended to include grouping asynchronous interactions into transactions (as described in detail herein). FIG. 2 is a block diagram illustrating a data structure 200 of the GPS_MAP event record 202, according to one embodiment of the invention. The data structure 200 may contain a token identifier (token_ID) 206 and a transaction identifier (tran_ID) 204.

FIG. 3 is a flow diagram depicting a process 300 for creating the GPS_MAP event record 202, according to one embodiment of the invention. The process begins at step 302, when the interaction routing system (IRS) 150 receives an interaction from a first application 118. As described, an interaction may be a request by the first application 118 for information from a second application 118, or may be a message from the first application 118 to the second application 118.

In step 304, as outlined in End-to-End Transaction Tracking in the Enterprise, the IRS 150 may route the interaction to the second application 118, as may be designated in the header portion of the interaction or in accordance with a pre-defined interaction routing plan stored in the IRS 150. In one embodiment, additional functionality may be added to the IRS 150 so that the GPS_MAP event record 202 may be used. Therefore, in step 302, the IRS 150 may create an empty GPS_MAP data structure 200.

At step 306, the IRS 150 may analyze the interaction, determine its token identifier 206 and populate the empty data structure 200 with the token identifier 206 from the interaction. The token identifier 206 may be used by the interaction monitor 152 to associate the GPS_MAP event record 202 with other event records containing the same token identifier 206.

In one embodiment, in step 308, the IRS 150 may generate a transaction identifier 204 by applying an externally specified rule to the interaction. The transaction identifier may be used to associate each interaction with a transaction, as described below, and the externally specified rule may be defined by the IRS 150, or may be predefined by a user of the IRS 150. Rules may be based on any feature of the interaction. For example, the IRS 150 may be instructed to identify transactions based on data contained within the interaction, an identity of an interaction's originating application 118, an identity of an interaction's receiving application 118, a network path traveled by the interaction, and/or a data size of an interaction.

In one embodiment, once the transaction identifier 204 has been generated, the transaction identifier 204 may be added to the data structure 200, as in step 310. In step 312, the completed GPS_MAP event record 202 may be sent to the interaction monitor 152, where the GPS_MAP event record 202 may become associated with multiple event records received by the interaction monitor 152 that may contain the same token identifier. Accordingly, each interaction described by multiple event records may become associated with the transaction identifier 204 contained within the GPS_MAP event record.

Alternatively, the GPS_MAP event record may be generated by an application monitor 120 or any other application 118 configured to analyze the interactions traveling over the network. Although the correlating event record GPS_MAP is defined above in reference to a particular embodiment, one skilled in the art will recognize that a correlating event record may be named anything and may contain numerous other fields not described above. For example, the event record may contain a timestamp, an identification of the server which generated the correlating event record, and/or a number of instances of a particular transaction identifier.

### Application of a Correlating Event Record to a Messaging Environment

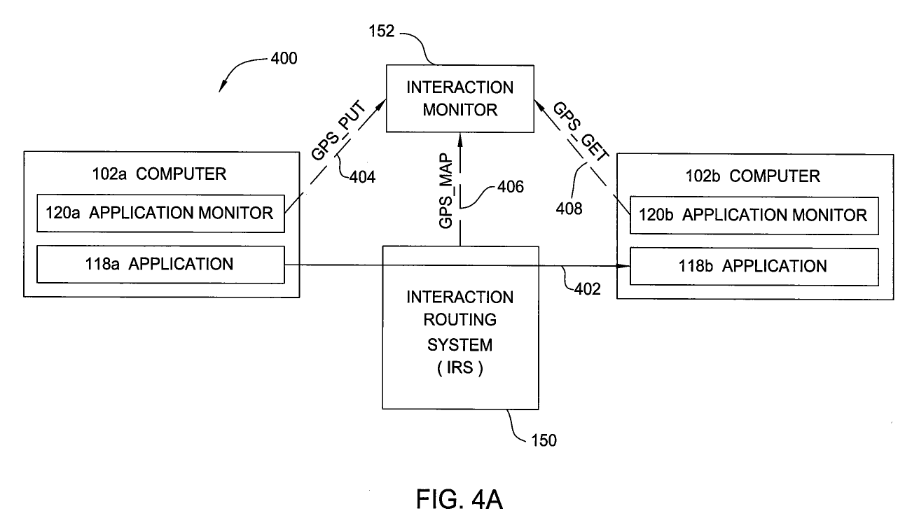

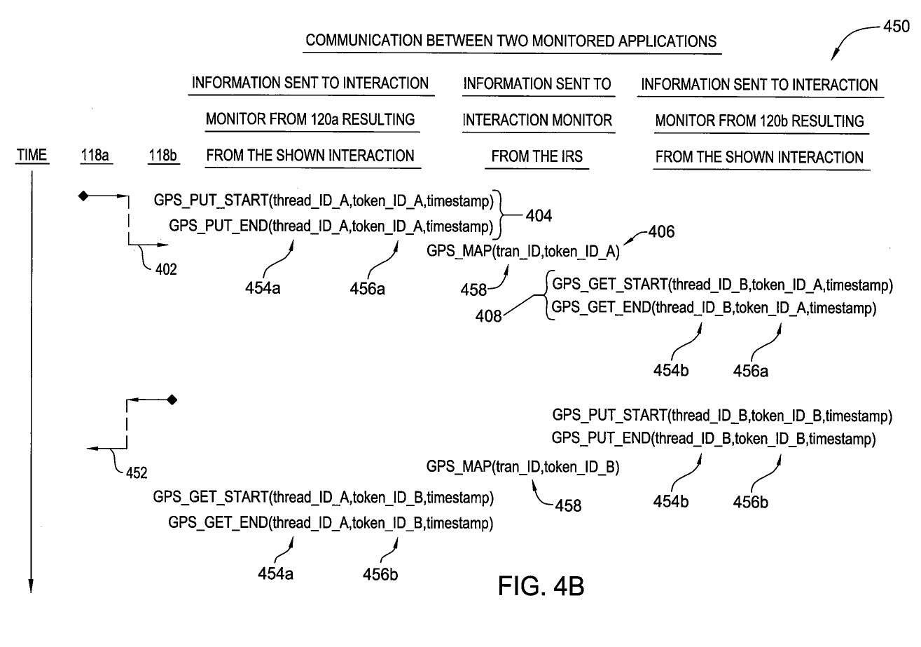

In one embodiment, not all applications 118 have related application monitors 120. Therefore, four potential scenarios may exist for interactions between two applications: an interaction from a monitored application 118 to a monitored application 118; an interaction from a non-monitored application 118 to a monitored application 118, called a hybrid interaction; an interaction from a monitored application 118 to a non-monitored application 118, also a hybrid interaction; and, an interaction from a non-monitored application 118 to another non-monitored application 118. FIGS. 4A through 7B illustrate various embodiments for monitoring interactions and transactions configured for each scenario described above, as is described below.

### Interaction Between Two Monitored Applications

In one embodiment, an application 118 may have an associated application monitor 120. When the application 118 sends a message, the application monitor 120 may send GPS_PUT_START and GPS_PUT_END (hereinafter GPS_PUT) event records to the interaction monitor 152. Similarly, when the application 118 receives a message, the application monitor 120 may send GPS_GET_START and GPS_GET_END (hereinafter GPS_GET) event records to the interaction monitor 152. As described above, these event records may facilitate the tracking of messages (or more generally, interactions). Thus, each monitored component may include application monitor 120.

FIG. 4A is a block diagram illustrating a scenario 400 in which a first monitored application 118a sends a first interaction 402 to a second monitored application 118b, according to one embodiment of the invention. The first application 118a may be monitored by a first application monitor 120a, and the second application 118b may be monitored by a second application monitor 120b. As shown, the applications 118a, 118b are running on separate client computers 102a, 102b. However the applications 118a, 118b may run on the same client computer 102.

In one embodiment, when a first interaction 402 is sent from the first application 118a to the IRS 150 and then on to the second application 118b, the first application monitor 120a may send GPS_PUT event records 404 to the interaction monitor 152. Additionally, the IRS 150 may send a GPS_MAP event record 406 to the interaction monitor 152, and the second application monitor 120b may send GPS_GET event records 408 to the interaction monitor 152.

FIG. 4B illustrates the dataflow 450 from the application monitors 120a, 120b as well as the IRS 150 in scenario 400, according to one embodiment of the invention. An application identifier, or app_ID 454, is an identifier that may indicate the application 118 which caused a particular event record to be sent to the interaction monitor 152. Therefore, event records from the first application monitor 120a contain app_ID_A 454a and event records from the second application monitor 120b contain app_ID_B 454b.

Dataflow 450 also illustrates the second application 118b sending a second interaction 452 to the first application 118a. In the second interaction 452, a token identifier 456b is different than a token identifier 456a in the first interaction 402 because each individual interaction generally has its own unique token identifier 456, thus allowing the interaction monitor 150 to identify each separate interaction. However, in both the first and second interactions 402, 452, the transaction identifiers 458 are identical, indicating that the two interactions 402, 452 may be part of the same transaction.

In one embodiment, the GPS_MAP event record may be sent to the interaction monitor 152 by the first application monitor 120a or the second application monitor 120b instead of the IRS 150. This may occur for a variety of reasons. For example, the IRS 150 may not be configured to send GPS_MAP records; instead, the application monitor 120 may be so configured.

### Non-Monitored Application Sending an Interaction to a Monitored Application

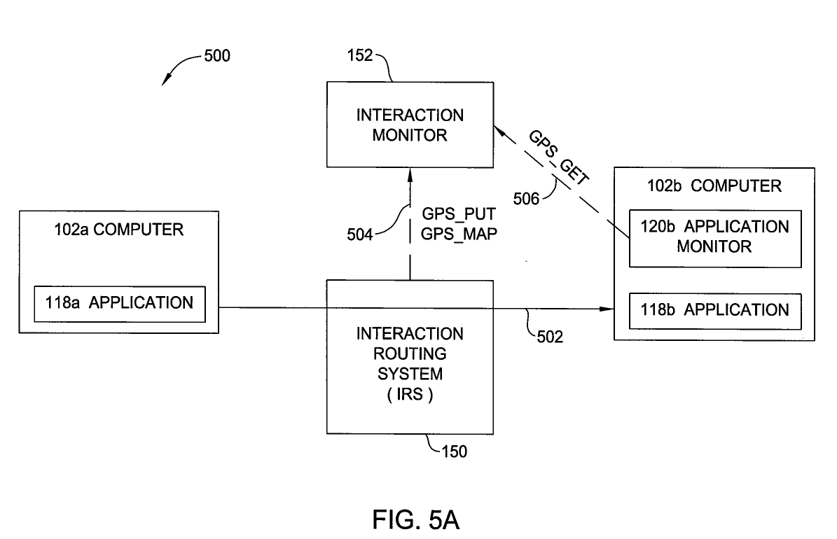

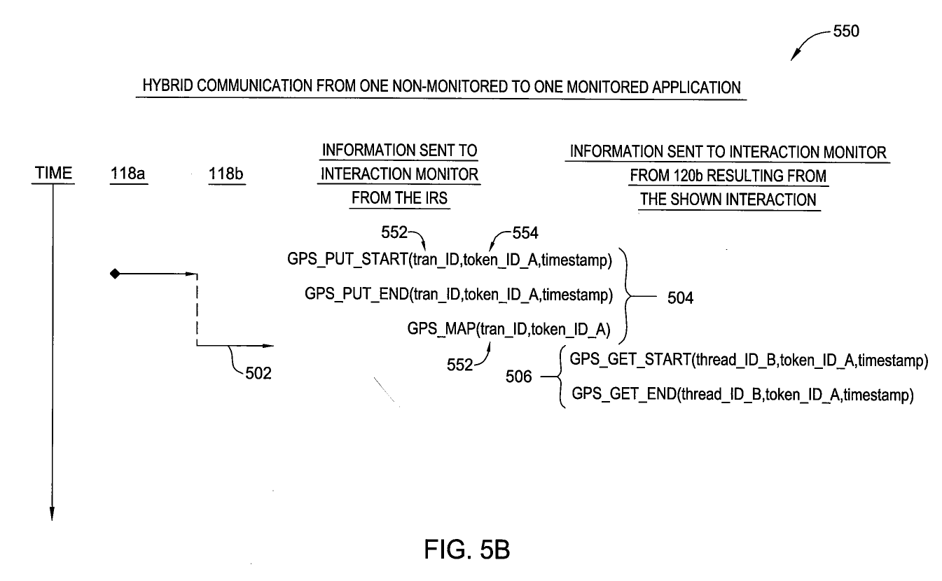

FIG. 5A is a block diagram illustrating a scenario 500 in which a non-monitored first application 118a sends an interaction 502 to a monitored second application 118b, according to one embodiment of the invention. The second application 118b may be monitored by an application monitor 120b. As shown, the applications 118a, 118b are running on separate client computers 102a, 102b. However the applications 118a, 118b may run on the same client computer 102.

In one embodiment, when an interaction 502 is sent from the first application 118a to the IRS 150 and then on to the second application 118b, the IRS 150 may send GPS_PUT and GPS_MAP event records 504 to the interaction monitor 152. Furthermore, the application monitor 120b may send GPS_GET event records 506 to the interaction monitor 152. Importantly, this may allow complete monitoring of a transaction where not all components are monitored.

FIG. 5B illustrates the dataflow 550 from the application monitor 120b as well as the IRS 150 in scenario 500, according to one embodiment of the invention. In scenario 500, a configuration file on the IRS 150 may specify that the first application 118a is not monitored. Therefore, the IRS 150 may send the GPS_PUT event records associated with the first application 118a in addition to the GPS_MAP event record so that a complete record of the interaction 502 may be present on the interaction monitor.

In one embodiment, the configuration file on the IRS 150 may not specify the application identifier associated with the first application 118a, and therefore the IRS 150 may substitute the same transaction identifier 552 used with the GPS_MAP event record into the GPS_PUT event records. Alternatively, the configuration file on the IRS 150 may specify the application identifier associated with the first application 118a, and the IRS 150 may include that application identifier in the GPS_PUT event records. Thus, the event records received by the interaction monitor 152 may be as complete as those described above with reference to FIGS. 4A and 4B. In either case, the interaction monitor 152 may use the event records to fully characterize an interaction, including relating the interaction to a transaction. In exemplary scenario 500, no token identifier 554 may pass to the IRS 150 from the first application 118a. Therefore, the IRS 150 may generate the token identifier 554 for the interaction 502.

In one embodiment, the GPS_PUT and GPS_MAP event records may be sent to the interaction monitor 152 by the application monitor 120b instead of the IRS 150. This may occur for a variety of reasons. For example, the IRS 150 may not be configured to send event records; instead, the application monitor 120 may be so configured. Alternatively, the IRS 150 and the application monitor 120 may communicate to determine which of the two has more data available to describe an interaction before determining which of the two will send the event records associated with the interaction.

### Monitored Application Sending an Interaction to a Non-Monitored Application

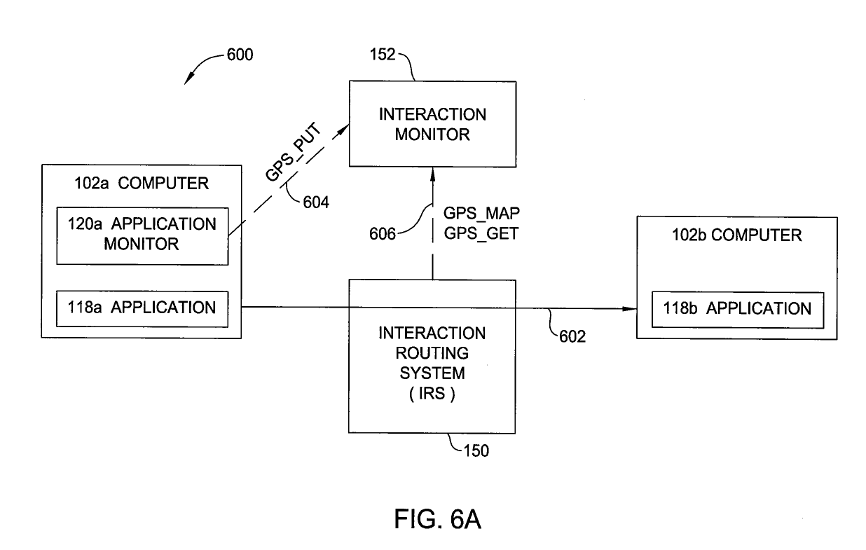

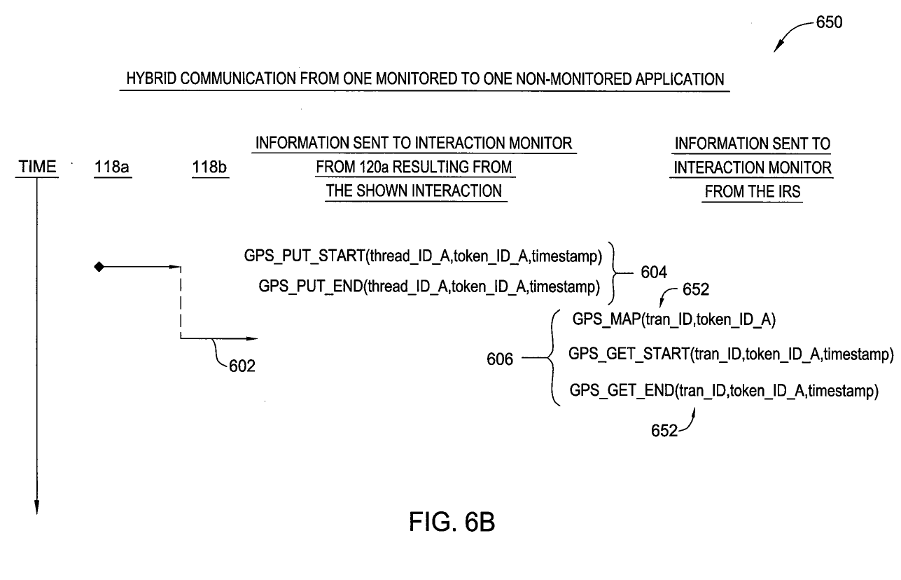

FIG. 6A is a block diagram illustrating a scenario 600 in which a monitored first application 118a sends an interaction 602 to a non-monitored second application 118b, according to one embodiment of the invention. The first application 118a may be monitored by an application monitor 120a. As shown, the applications 118a, 118b are running on separate client computers 102a, 102b. However the applications 118a, 118b may run on the same client computer 102.

In one embodiment, when an interaction 602 is sent from the first application 118a to the IRS 150, and then on to the second application 118b, the application monitor 120a may send GPS_PUT event records 604 to the interaction monitor 152. Furthermore, the IRS 150 may send GPS_MAP and GPS_GET event records 606 to the interaction monitor 152. Importantly, this may allow complete monitoring of a transaction where not all components are monitored.

FIG. 6B illustrates the dataflow 650 from the application monitor 120a as well as the IRS 150 in scenario 600, according to one embodiment of the invention. In scenario 600, a configuration file on the IRS 150 may specify that the second application 118b is not monitored. Therefore, the IRS 150 may send the GPS_MAP event record as well as the GPS_GET event records associated with the second application 118b so that a complete record of the interaction 602 may be present on the interaction monitor.

In one embodiment, the configuration file on the IRS 150 may not specify the application identifier associated with the second application 118b, and therefore the IRS 150 may substitute the same transaction identifier 652 used with the GPS_MAP event record into the GPS_GET event records. Alternatively, the configuration file on the IRS 150 may specify the application identifier associated with the second application 118b, and the IRS 150 may include that application identifier in the GPS_GET event records. Thus, the event records received by the interaction monitor 152 may be as complete as those described above with reference to FIGS. 4A and 4B. In either case, the interaction monitor 152 may use the event records to fully characterize an interaction, including relating the interaction to a transaction.

In one embodiment, the GPS_MAP and GPS_GET event records may be sent to the interaction monitor 152 by the application monitor 120a instead of the IRS 150. This may occur for a variety of reasons. For example, the IRS 150 may not be configured to send event records; instead, the application monitor 120 may be so configured. Alternatively, the IRS 150 and the application monitor 120 may communicate to determine which of the two has more data available to describe an interaction before determining which of the two will send the event records associated with the interaction.

### Interaction Between Two Non-Monitored Applications

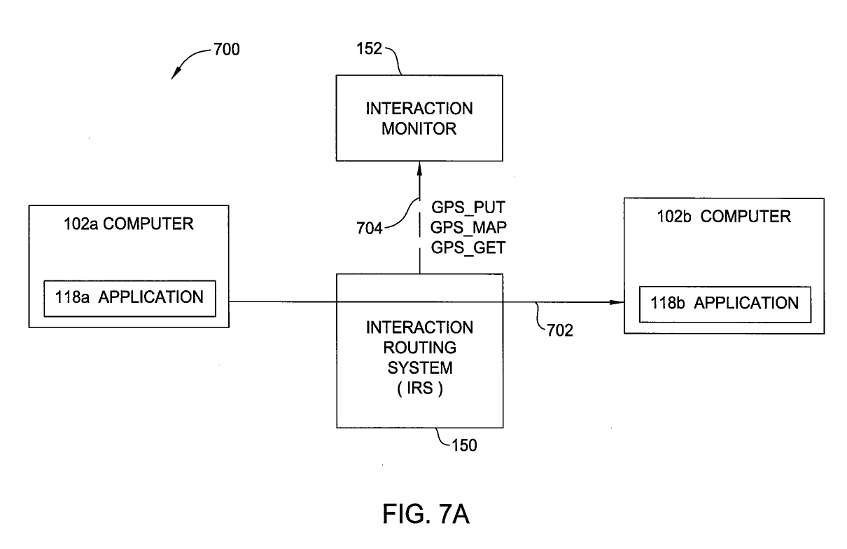

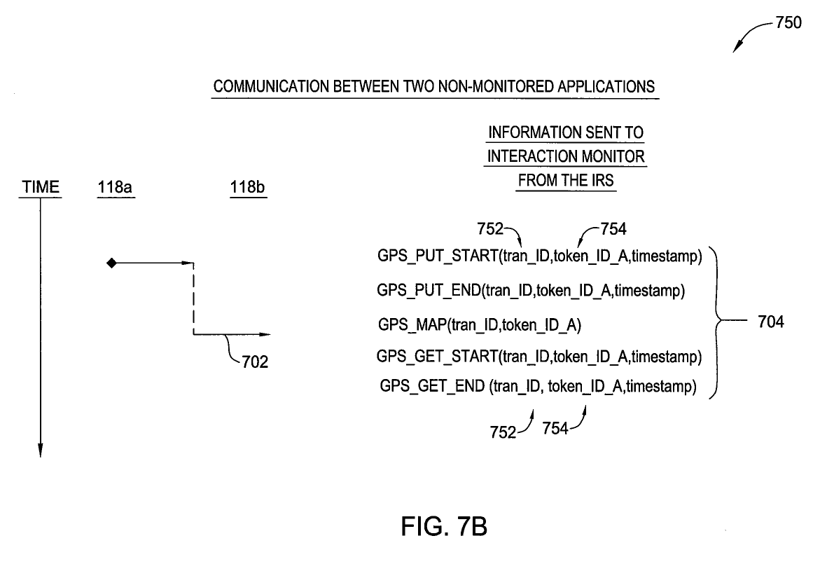

FIG. 7A is a block diagram illustrating a scenario 700 in which a non-monitored first application 118a sends an interaction 702 to a non-monitored second application 118b, according to one embodiment of the invention. As shown, the applications 118a, 118b are running on separate client computers 102a, 102b. However the applications 118a, 118b may run on the same client computer 102.

In one embodiment, when an interaction 702 is sent from the first application 118a to the IRS 150, and then on to the second application 118b, the IRS 150 may send GPS_PUT, GPS_MAP, and GPS_GET event records 704 to the interaction monitor 152. Importantly, this may allow complete monitoring of a transaction where not all components are monitored.

FIG. 7B illustrates the dataflow 750 from the IRS 150 in scenario 700, according to one embodiment of the invention. In the depicted scenario 700, the IRS 150 may know that neither application 118a, 118b is monitored. Therefore, the IRS 150 may send the GPS_MAP event record as well as the GPS_PUT and GPS_GET event records associated with the first and second applications 118a, 118b so that a complete record of the interaction 702 may be present on the interaction monitor.

In one embodiment, a configuration file on the IRS 150 may not specify the application identifier associated with either application 118a, 118b and therefore the IRS 150 may substitute the same transaction identifier 752 used with the GPS_MAP event record into the GPS_PUT and GPS_GET event records. Alternatively, the configuration file on the IRS 150 may specify the application identifier associated with the one or both applications 118a, 118b, and the IRS 150 may include that application identifier in one or both of the GPS_PUT and/or GPS_GET event records. Thus, the event records received by the interaction monitor 152 may be as complete as those described above with reference to FIGS. 4A and 4B. In either case, the interaction monitor 152 may use the event records to fully characterize an interaction, including relating the interaction to a transaction. In exemplary scenario 700, no token identifier 754 may pass to the IRS 150 from the first application 118a. Therefore, the IRS 150 may generate the token identifier 754 for the interaction 702.

In one embodiment, the configuration file on the IRS 150 may not specify whether or not a given application 118 has an application monitor 120. Consequently, the IRS 150 may function on the assumption that the application 118 has no application monitor 120 and may send the necessary event records to the interaction manager 152, as described above. This assumption may be made safely because even if the application 118 was in fact monitored by an application monitor 120, the additional event records sent by the IRS 152 may be duplicate records which may be easily identified and corrected.

### Process for Determining which Event Records Should be Sent by the IRS

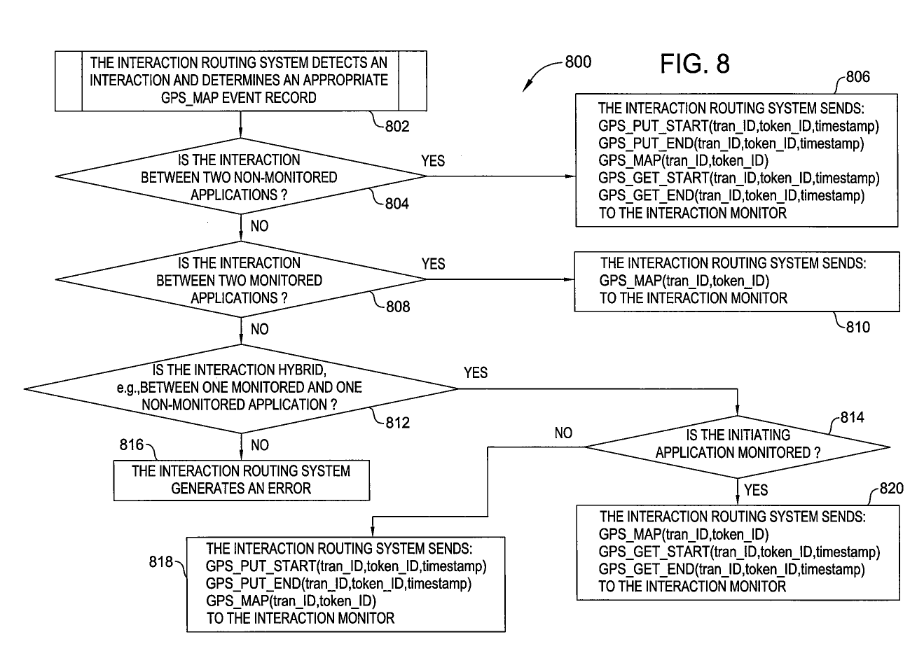

FIG. 8 is a flow diagram depicting a process 800 for determining which event records the interaction routing system 150 may send to the interaction monitor 152, according to one embodiment of the invention. The process begins at step 802, where the IRS 150 detects an interaction and generates an appropriate GPS_MAP event record, as described above with respect to the process 300.

At step 804, the IRS 150 determines whether the interaction is between two non-monitored applications 118. If neither the initiating nor the receiving application 118 is monitored, then at step 806, the IRS 150 generates and sends GPS_PUT, GPS_MAP, and GPS_GET event records to the interaction monitor 152.

Otherwise, at step 808, the IRS 150 determines whether an initiating application 118 and a receiving application 118 are both monitored. If so, at step 810, the IRS 150 generates and sends the GPS_MAP event record to the interaction monitor 152.

Otherwise, the interaction is a hybrid interaction between one monitored application 118 and one non-monitored application 118, which the IRS 150 verifies at step 812. If the IRS 150 determines that the interaction is not hybrid, as in step 816, an error may have occurred and the IRS 150 may ignore the interaction. Alternatively, the IRS 150 may log the error.

If the verifies, in step 812, that the interaction is between a monitored application 118 and a non-monitored application 118, the process 800 may proceed to step 814, where the IRS 150 may determine whether the application 118 initiating the interaction is monitored. If the initiating application 118 is monitored, the process 800 may proceed to step 820, where the IRS 150 generates and sends the GPS_MAP and GPS_GET event records to the interaction monitor 152.

Otherwise, the initiating application 118 is not monitored, and the process 800 may proceed to step 818, where the IRS 150 generates and sends the GPS_PUT and GPS_MAP event records to the interaction monitor 152.

In one embodiment, the event records may be sent to the interaction monitor 152 by an application monitor 120 or another application with knowledge of communications on the network 116 that may not necessarily be the IRS 150.

### Process for Associating an Interaction with a Transaction

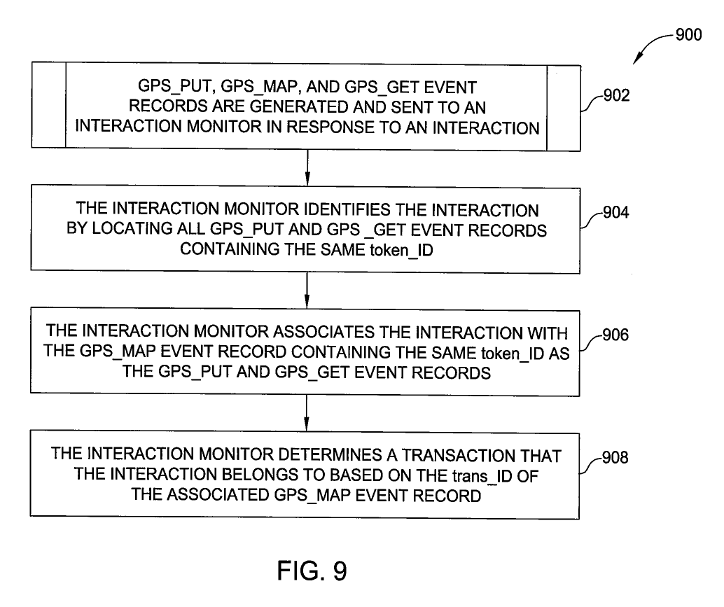

FIG. 9 is a flow diagram depicting a process 900 for determining an interaction's transaction, according to one embodiment of the invention. The process may begin at step 902, where GPS_PUT, GPS_MAP and GPS_GET event records may be generated and sent to an interaction monitor 102, as described above with respect to process 800.

At 904, the interaction monitor 152 may define an interaction by locating all GPS_PUT and GPS_GET event records containing the same token identifier, as described above. A complete set of GPS_PUT and GPS_GET event records may fully define the transmission of an interaction over a network 116.

Once the interaction has been defined, then at step 906, the interaction monitor 152 may associate the interaction with the GPS_MAP event record containing the same token identifier as the GPS_PUT and GPS_GET event records which defined the interaction.

At step 908, the association may be made by the interaction monitor 152 that links the transaction identifier in the GPS_MAP event record with the interaction. If more than one interaction has the same transaction identifier, the interactions may be part of the same transaction.

In one embodiment, one or more GPS_PUT and/or GPS_GET commands defining an interaction may not be present on the interaction monitor 152. In this case, the interaction monitor 152 may use the partial set of event records to associate the partially defined interaction with a given transaction.

Advantageously, embodiments of the invention allow both synchronous and asynchronous interactions to be correlated into groups where each interaction in the group is part of the same task, job or function (i.e., part of the same transaction). Furthermore, correlation may occur when an interaction involves monitored and/or non-monitored applications. This allows a systems administrator to analyze performance characteristics of the elements of individual transactions from otherwise indistinguishable sets of interactions.

While the foregoing is directed to embodiments of the present invention, other and further embodiments of the invention may be devised without departing from the basic scope thereof, and the scope thereof is determined by the claims that follow.

What is claimed is:

1. A computer-implemented method of tracking an asynchronous communication between two applications, comprising:
receiving a first event record associated with a first application, wherein the first event record indicates that the first application sent a first communication to a second application;
receiving a second event record associated with the second application, wherein the second event record indicates that the second application received a second communication from the first application;
determining whether the second communication corresponds to the first communication; and
receiving a third event record from a monitoring application configured to monitor communications between the first application and the second application, wherein the third event record includes a transaction identifier used to correlate the first and second event records as belonging to a group of one or more event records related to a common transaction.

2. The method of claim 1, wherein:
the first event record comprises a first application identifier and a first token;
the second event record comprises a second application identifier and a second token; and
the third event record further comprises a third token.

3. The method of claim 2, wherein determining whether the second communication received by the second application corresponds to the first communication sent by the first application comprises determining whether the first token and the second token match.

4. The method of claim 2, further comprising correlating the first and second event records with a group of one or more event records related to a common transaction, wherein correlating comprises:
determining whether the third event record corresponds to the first and second event records by determining whether the first, second, and third tokens match; and
if so, correlating the first and second event records with a group of one or more event records containing the same transaction identifier, thereby defining a transaction.

5. The method of claim 2, further comprising applying a rule to a third communication to generate the transaction identifier, wherein the third communication corresponds to the first communication sent by the first application if the first token and the third token match.

6. The method of claim 5, wherein the rule is an externally specified rule which dictates how the transaction identifier is generated from one or more of data contained within the third communication, a sending application of the third communication, a receiving application of the third communication, a path taken by the third communication through a computer network, and a size of the third communication.

7. The method of claim 1, wherein the asynchronous communication is one of a message and an invocation.

8. The method of claim 7, wherein the asynchronous communication is one of a Customer Information Control System (CICS®) invocation, a Java® application server method invocation, a WebSphere® MQ application server message, an Information Management System (IMS) message, a Weblogic® communication, and a WebSphere® application server (WAS) invocation.

9. A computer program product comprising a computer useable medium including a computer readable program, wherein the computer readable program when executed on a computer causes the computer to perform an operation, comprising:
receiving a first event record associated with a first application, wherein the first event record indicates that the first application sent a first communication to a second application;
receiving a second event record associated with the second application, wherein the second event record indicates that the second application received a second communication from the first application;
determining whether the second communication corresponds to the first communication; and
receiving a third event record from a monitoring application configured to monitor communications between the first application and the second application, wherein the third event record includes a transaction identifier used to correlate the first and second event records as belonging to a group of one or more event records related to a common transaction.

10. The computer program product of claim 9, wherein:
the first event record comprises a first application identifier and a first token;
the second event record comprises a second application identifier and a second token; and
the third event record further comprises a third token.

11. The computer program product of claim 10, wherein determining whether the second communication received by the second application corresponds to the first communication sent by the first application comprises determining whether the first token and the second token match.

12. The computer program product of claim 10, wherein the operation further comprises correlating the first and second event records with a group of one or more event records related to a common transaction, wherein correlating comprises:
determining whether the third event record corresponds to the first and second event records by determining whether the first, second, and third tokens match; and
if so, correlating the first and second event records with a group of one or more event records containing the same transaction identifier, thereby defining a transaction.

13. The computer program product of claim 10, wherein the operation further comprises applying a rule to a third communication to generate the transaction identifier, wherein the third communication corresponds to the first communication sent by the first application if the first token and the third token match.

14. The computer program product of claim 13, wherein the rule is an externally specified rule which dictates how the transaction identifier is generated from one or more of data contained within the third communication, a sending application of the third communication, a receiving application of the third communication, a path taken by the third communication through a computer network, and a size of the third communication.

15. A system for monitoring communications between applications in a distributed computing environment, comprising:
a first application configured to send a first communication to a second application, wherein the first communication corresponds to a first event record;
the second application configured to receive a second communication from the first application, wherein the second communication corresponds to a second event record;
a managing server configured to:
determine whether the second communication corresponds to the first communication; and
receive a third event record from a monitoring application configured to monitor communications between the first application and the second application, wherein the third event record includes a transaction identifier used to correlate the first and second event records as belonging to a group of one or more event records related to a common transaction.

16. The system of claim 15, wherein:
the first event record comprises a first application identifier and a first token;
the second event record comprises a second application identifier and a second token; and
the third event record further comprises a third token.

17. The system of claim 16, wherein the managing server is further configured to determine whether the second communication corresponds to the first communication by being configured to determine whether the first token and the second token match.

18. The system of claim 16, wherein the managing server is further configured to:
determine whether the third event record corresponds to the first and second event records by determining whether the first, second, and third tokens match; and
if so, correlating the first and second event records with a group of one or more event records containing the same transaction identifier, thereby defining a transaction.

19. The system of claim 16, wherein the monitoring application is further configured to apply a rule to a third communication to generate the transaction identifier, wherein the third communication corresponds to the first communication sent by the first application if the first token and the third token match.

20. The system of claim 19, wherein the rule is an externally specified rule which dictates how the transaction identifier is generated from one or more of data contained within the third communication, a sending application of the third communication, a receiving application of the third communication, a path taken by the third communication through a computer network, and a size of the third communication.

21. A method of tracking discrete elements of a distributed transaction in an asynchronous processing environment, comprising:
monitoring a plurality of applications configured to process the distributed transaction; and
correlating an asynchronous data communication from a first application to a second application within the asynchronous processing environment as being a part of the distributed transaction, wherein the asynchronous data communication is a discrete element of the distributed transaction.

22. The method of claim 21, wherein monitoring comprises:
monitoring the asynchronous data communication between the first application and the second application;
generating an event record describing the communication;
sending the event record to a managing server; and
correlating the event record with related event records to describe the processing of the asynchronous data communication.

23. The method of claim 21, wherein correlating comprises:
comparing a first set of one or more event records which describe a first asynchronous data communication to a second set of one or more event records which describe other asynchronous data communications;
identifying a subset of event records from the second set of event records which contain a same transaction identifier as the first set of event records; and
if any such subset of event records exists, determining that the first asynchronous data communication and asynchronous data communications described by the subset of event records are parts of the distributed transaction.
